(19) United States
(12) Patent Application Publication
(10) Pub. No.: US 2025/0384203 A1
(43) Pub. Date: Dec. 18, 2025

(54) METHOD, APPARATUS, DEVICE AND STORAGE MEDIUM FOR CONTENT GENERATION

(71) Applicant: Beijing Zitiao Network Technology Co., Ltd., Beijing (CN)

(72) Inventor: Kaiwen Liu, Beijing (CN)

(21) Appl. No.: 19/236,019

(22) Filed: Jun. 12, 2025

Related U.S. Application Data
(63) Continuation of application No. PCT/CN2024/098771, filed on Jun. 12, 2024.

(51) Int. Cl. G06F 40/166

(52) U.S. Cl. CPC G06F 40/166

(57) ABSTRACT

According to embodiments of the disclosure, a method, an apparatus, a device, and a storage medium for content generation are provided. A method includes in response to a selection of a target template, presenting a text configuration region included in the target template; receiving target identification information based on an operation on the text configuration region, the target identification information indicating one or more attribute values for a text attribute of the text configuration region; and based on the target identification information and the target template, generating one or more contents to be distributed respectively corresponding to the one or more attribute values, wherein each content to be distributed has a corresponding attribute value in the text configuration region. Thus, contents with various text attribute values can be generated in a batch, thereby improving flexibility of content generation.

### CROSS-REFERENCE

The present application claims priority to PCT Application No. PCT/CN2024/098771, filed on Jun. 12, 2024, and entitled “METHOD, APPARATUS, DEVICE AND STORAGE MEDIUM FOR CONTENT GENERATION”, the entirety of which is incorporated herein by reference.

### FIELD

Example embodiments of the present disclosure generally relate to the field of computers, and more particularly, to a method, apparatus, device, and computer-readable storage medium for content generation.

### BACKGROUND

The Internet provides access to various types of resources. For example, a variety of applications, goods, audio-video contents, and so on, can be accessed through the Internet. In addition, content distribution via the Internet has been widely used as a new form of information dissemination. The distributed content may be used, for example, for campaign promotion, service promotion, etc. Accordingly, with the development of information globalization, the objects of content distribution are becoming increasingly diverse. For example, the situation of facing multiple languages is increasingly common.

### SUMMARY

In a first aspect of the present disclosure, a method of content generation is provided. The method includes: in response to a selection of a target template, presenting a text configuration region included in the target template; receiving target identification information based on an operation on the text configuration region, the target identification information indicating one or more attribute values for a text attribute of the text configuration region; and based on the target identification information and the target template, generating one or more contents to be distributed respectively corresponding to the one or more attribute values, wherein each content to be distributed has a corresponding attribute value in the text configuration region.

In a second aspect of the present disclosure, an apparatus for content generation is provided. The apparatus includes: a region presenting module configured to present, in response to a selection of a target template, a text configuration region included in the target template; an information receiving module configured to receive target identification information based on an operation on the text configuration region, the target identification information indicating one or more attribute values for a text attribute of the text configuration region; and a content generation module configured to generate one or more contents to be distributed respectively corresponding to the one or more attribute values based on the target identification information and the target template, wherein each content to be distributed has a corresponding attribute value in the text configuration region.

In a third aspect of the present disclosure, an electronic device is provided. The device includes at least one processing unit and at least one memory coupled to the at least one processing unit and storing instructions for execution by the at least one processing unit. The instructions, when executed by the at least one processing unit, cause the apparatus to perform the method of the first aspect.

In a fourth aspect of the present disclosure, a computer readable storage medium is provided, wherein the computer readable storage medium stores a computer program, and the computer program is executable by a processor to implement the method in the first aspect.

It would be appreciated that the content described in this section is not intended to limit key features or important features of the embodiments of the present disclosure, nor is it intended to limit the scope of the disclosure. Other features of the present disclosure will become readily appreciated from the following description.

### BRIEF DESCRIPTION OF THE DRAWINGS

The above and other features, advantages, and aspects of various embodiments of the present disclosure will become more apparent from the following detailed description with reference to the accompanying drawings. In the drawings, the same or similar reference numbers refer to the same or similar elements, wherein:

FIG. 1 illustrates a schematic diagram of an example environment in which embodiments of the present disclosure may be implemented;

FIGS. 2A to 2D illustrate schematic diagrams of example interfaces for content generation according to some embodiments of the present disclosure;

FIG. 3 illustrates a flow diagram of a process for content generation according to some embodiments of the present disclosure;

FIG. 4 illustrates a block diagram of an apparatus for content generation according to some embodiments of the present disclosure; and

FIG. 5 illustrates a block diagram of a device in which various embodiments of the present disclosure may be implemented.

### DETAILED DESCRIPTION

It would be appreciated that before the technical solution disclosed in the embodiments of the present disclosure is used, users should be informed of the type, the scope of use, the use scenario, etc. of the personal information involved in the present disclosure in an appropriate manner and the authorization of the users should be obtained in accordance with relevant laws and regulations.

For example, in response to an active request being received from a user, prompt information is sent to the user to explicitly prompt the user that an operation requested by the user will need to obtain and use the personal information of the user. Thus, the user can autonomously select, according to the prompt information, whether to provide the personal information to the software or the hardware such as an electronic device, an application program, a server, or a storage medium that performs the operations of the technical solution of the present disclosure.

As an optional but non-limited implementation, in response to the active request being received from the user, the prompt information may be sent to the user via, for example, a pop-up window in which the prompt information may be presented in text. In addition, the popup window may also contain selection controls configured for the user to choose “agree” or “disagree” to provide the personal information to the electronic device.

It would be appreciated that the above process of notification and acquisition of user authorization are merely exemplary, and do not limit the implementations of the present disclosure. Other methods that meet relevant laws and regulations may also be applied to the implementations of the present disclosure.

It would be appreciated that the data involved in the technical solution (including but not limited to the data itself, data acquisition or use) shall comply with the requirements of corresponding laws, regulations and relevant provisions.

The embodiments of the present disclosure will be described in more detail below with reference to the accompanying drawings. Although certain embodiments of the present disclosure are shown in the drawings, it would be appreciated that the present disclosure can be implemented in various forms and should not be interpreted as limited to the embodiments described herein. On the contrary, these embodiments are provided for a more thorough and complete understanding of the present disclosure. It would be appreciated that the accompanying drawings and the embodiments of the present disclosure are only for the purpose of illustration and are not intended to limit the scope of protection of the present disclosure.

It should be noted that the headline of any section/subsection provided in the specification is not limiting. Various embodiments are described throughout the specification and any type of embodiments may be included in any section/subsection. Furthermore, the embodiments described in any section/subsection may be combined in any manner with any other embodiment described in the same section/subsection and/or different sections/subsections.

Herein, unless explicitly stated otherwise, performing a step “in response to A” does not mean that the step is performed immediately after “A”, but may include one or more intermediate steps.

In the description of the embodiments of the present disclosure, the term “including” and the like should be appreciated as open-ended inclusion, that is, “including but not limited to”. The term “based on” should be appreciated as “based at least in part on”. The term “an embodiment” or “the embodiment” should be appreciated as “at least one embodiment”. The term “some embodiments” should be appreciated as “at least some embodiments”. Other explicit and implicit definitions may also be included below. The terms “first”, “second”, etc. may refer to different or identical objects. Other explicit and implicit definitions may also be included below.

As mentioned above, with the rapid development of information globalization, the objects of the content distribution are becoming increasingly diverse. Accordingly, cases involving a variety of text attributes (for example, a variety of languages) are more and more common and complicated. At present, in content generation, if a variety of text effects are desired to be configured, different text attributes (for example, different languages) need to be input in a text configuration region (for example, an input box of “Title”/“Subtitle”/“Description Information”) of a template. For example, if the user needs to change from English to Japanese, then the information (e.g., “Title”/“Subtitle”/“Description Information”) needs to be refilled again in Japanese. In this example, it is complicated to switch among different text attributes. Further, currently, to view the template effects under different text attributes, the user needs to first find the position of the text in the template, and then click the switching control. Since there are a large number of template elements, it is difficult to distinguish and identify the text using such positioning method, and the configuration efficiency is low.

The embodiments of the present disclosure provide a solution for content generation. According to various embodiments of the present disclosure, if a user selects a target template, a terminal device presents a text configuration region included in the target template. Accordingly, target identification information is received according to an operation on the text configuration region. The target identification information indicates one or more attribute values for a text attribute of the text configuration region. Then, based on the target identification information and the target template, one or more contents to be distributed corresponding to the one or more attribute values are generated. Each content to be distributed has a corresponding attribute value in the text configuration region. As such, contents with different attribute values, such as contents of a plurality of languages and contents of a plurality of styles, can be generated in a batch.

### Example Environment

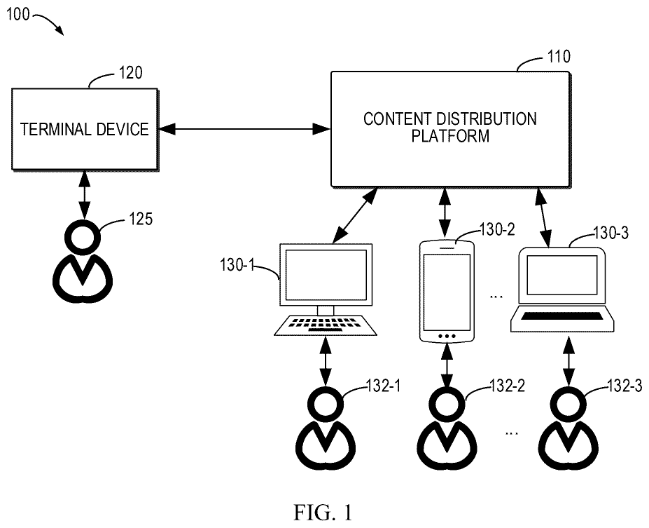

FIG. 1 shows a schematic diagram of an example environment 100 in which embodiments of the present disclosure can be implemented. A user 125 (which may also sometimes be referred to as a “content originator” or “activity originator”) can use a terminal device 120 to create and/or manage a content to be distributed on a content distribution platform 110. One or more client devices 130-1, 130-2, 130-3, etc. (collectively or individually referred to as client devices 130 for discussion purposes) are associated with the content distribution platform 110 and can access various types of content provided on the content distribution platform 110, such as based on respective users 132-1, 132-2, 132-3, etc. (collectively or individually referred to as users 132 for discussion purposes). By way of example, the content distribution platform 110 may be an application, website, web page, or any other accessible platform. The client device 130 may have an application installed for accessing the content distribution platform 110, or may access the content distribution platform 110 in a suitable manner. The content distribution platform 110 may be configured to post, to users, the content created by the content originator using the terminal device 120 (e.g., provide or present it on the client device 130). For example, the content originator may create the content for campaign advertising or service promotion.

In the environment 100, the terminal device 120 and the client device 130 may be any type of mobile terminal, fixed terminal, or portable terminal, comprising a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a game device, or any combination of the foregoing, including accessories and peripherals for these devices, or any combination thereof. In some embodiments, the terminal device 120 and client device 130 can also support any type of interface to a user (such as a “wearable” circuit or the like). In the environment 100, the content distribution platform 110 may be, for example, various types of computing systems/servers capable of providing computing capabilities, including but not limited to mainframes, edge computing nodes, computing devices in a cloud environment, etc.

It should be appreciated that the structure and functions of the environment 100 are described for exemplary purposes only and are not intended to imply any limitation on the scope of the disclosure.

Some example embodiments of the present disclosure will be described below with continued reference to the drawings. It should be appreciated that the pages shown in the drawings are only examples, and that a variety of page designs may exist in practice. The various graphical elements in the page may have different arrangements and different visual representations, one or more of which may be omitted or replaced, and one or more other elements may also be present. The embodiments of the present disclosure are not limited in this regard. Furthermore, in the following, example embodiments will be primarily described with respect to the terminal device 120. It should be appreciated that the actions described with respect to the terminal device 120 may be performed by an application on the terminal device 120, or may be performed by an application in conjunction with its service end (e.g., the content distribution platform).

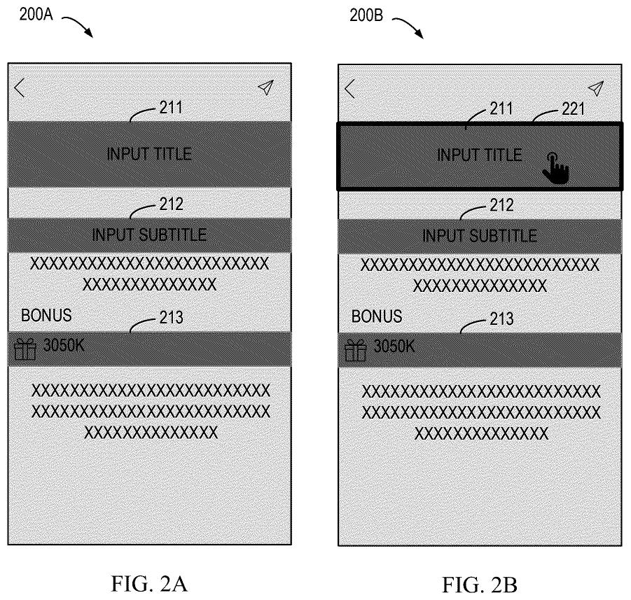

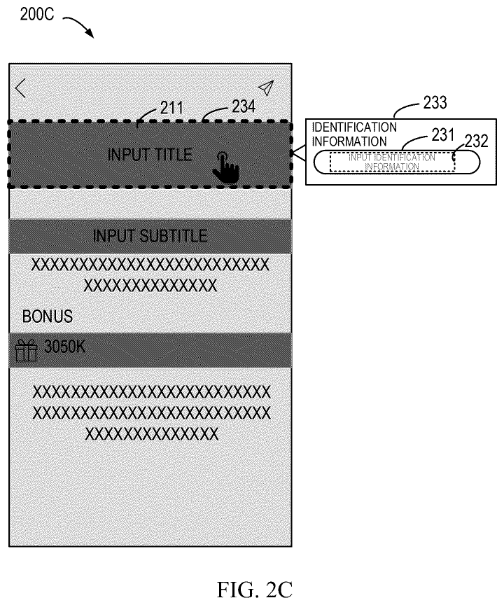

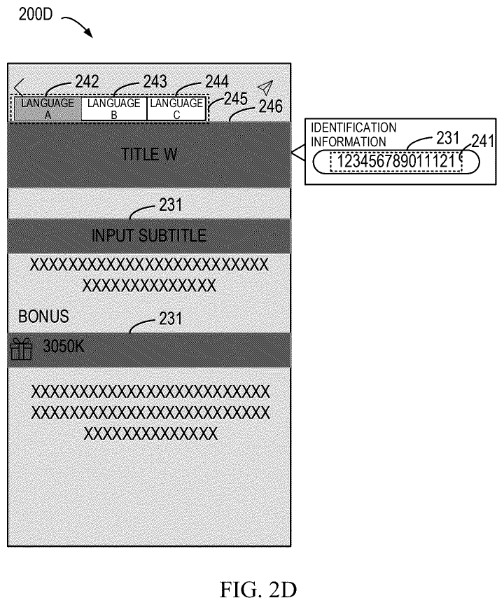

The solution of content generation in the present disclosure is described below with reference to FIGS. 2A to 2D. FIGS. 2A to 2D illustrate schematic diagrams of example interfaces 200A to 200D for content generation according to some embodiments of the disclosure.

In some embodiments, if the user 125 selects a target template, the terminal device 120 presents a text configuration region included in the target template. As in an exemplary interface 200A illustrated in FIG. 2A, the user selects the target template to generate a content to be distributed. In response to the user selection, the terminal device 120 presents a text configuration region included in the target template, such as a title configuration region 211, a subtitle configuration region 212, a bonus information configuration region 213, etc. In some examples, the text configuration region is presented for the user 125 to configure a variety of text attributes of the content to be distributed, e.g., a variety of languages, a variety of styles, etc.

In some embodiments, the terminal device 120 may determine the text configuration region in the following ways. In some examples, the terminal device 120 may determine a text to be updated in the target template, and then determine a region corresponding to the text to be updated as the text configuration region. In some examples, the terminal device 120 pre-determines a text to be updated in the target template, and determines a region corresponding to the text to be updated as the text configuration region.

As in the exemplary interface 200A illustrated in FIG. 2A, the terminal device 120 pre-determines “Input Title” in the target template. Then, the terminal device 120 determines the placement region of “Input Title” as the title configuration region 211. The terminal device 120 pre-determines “Input Subtitle” in the target template. Then, the terminal device 120 determines the placement region of “Input Subtitle” as the subtitle configuration region 212.

In some embodiments, the text configuration region is highlighted in a first style. As in the example interface 200A shown in FIG. 2A, the terminal device 120 highlights the title configuration region 211, the subtitle configuration region 212, the bonus information configuration region 213, and so on. Alternatively, the terminal device 120 may highlight a border of the text configuration region. The terminal device 120 may further display the text configuration region in various protruding modes, which is not limited in the present disclosure. In this way, the region for text configuration can be clearly seen by the user.

In some embodiments, the terminal device 120 determines preset information related to the target template, and determines a region where the preset information is placed as a pre-configuration region. In some embodiments, the pre-configuration region is displayed in a style different from that of the text configuration region. In some embodiments, the terminal device 120 determines information for which the text configuration is not needed as the preset information. Accordingly, a region where the preset information is placed is determined as the pre-configuration region The terminal device 120 presents the pre-configuration region in a style different from the first style. As shown in the example interface 200A in FIG. 2A, the terminal device 120 displays a region corresponding to the information for which the text configuration is not need with a mask. For example, displaying the pre-configuration region in gray, displaying the border of the pre-configuration region in gray, etc.

In some embodiments, after the text configuration region is presented, the terminal device 120 receives the target identification information according to the operation on the text configuration region. In some embodiments, the target identification information indicates one or more attribute values for the text attribute of the text configuration region. In some examples, the terminal device 120 receives the target identification information for the one or more attribute values of the text attribute in the text configuration region according to an operation of the user 125 in the text configuration region.

In some embodiments, the one or more text attributes indicated by the target identification information may be a language of text, a style of text, or a font of text. If the text attribute is the language of text, the attribute value corresponding to the language of the text may be Chinese, English, Japanese, Thai, or the like. If the text attribute is the style of text, the attribute value corresponding to the style of text may be, for example, a lively style, humorous style, dignified style, relaxed style, or the like. If the text attribute is the font of text, the attribute value corresponding to the font of text may be, for example, simplified Chinese font, artistic font, calligraphic font, or the like.

The user 125 or the terminal device 120 may obtain the target identification information in any suitable manner, and such target identification information may be used to obtain a target text with the indicated attribute values. For example only, the user 125 may provide a text (e.g., a title) to be filled in the target template to a text service platform (e.g., a text translation platform). The text service platform processes the text provided by the user 125 to generate texts having various attribute values. For example, in a case where the text attribute is the language of text, the text service platform may provide titles in multiple languages, such as a Chinese title, an English title, a Japanese title, and so on. As another example, in a where the text attribute is the style of text, the text service platform may provide texts with multiple styles, such as a title of the lively style, a title of the dignified style, and so on. The text service platform may store the generated texts in an accessible storage location so that the generated texts can be accessed and used based on the target identification information.

In some embodiments, the terminal device 120 receives the target identification information in the following ways. If the terminal device 120 detects the trigger operation on the text configuration region, the terminal device 120 presents a target input box and prompt information for prompting the user to input the identification information. Then, the terminal device 120 receives the target identification information through the target input box. In some examples, the prompt information for prompting the user to input the identification information may be placed in the target input box by the terminal device 120. Alternatively, the prompt information may be placed at a further location, such as a location above the input box or below the input box, or to be floating displayed in the region of the input box if the user clicks on the input box, etc.

As shown in example interfaces 200B to 200D in FIGS. 2B through 2D, if the user clicks on the title configuration region 211, the terminal device 120 presents an input box 231 and prompt information 232 (e.g., “Input identification information”). In some examples, the input box 231 presented by the terminal device 120 may be presented in a card 233. The prompt information 232 may be presented in the input box 231. Subsequently, the terminal device 120 receives identification information 241 input by the user in the input box 231.

In some embodiments, if a preset operation on the text configuration region is detected, the terminal device 120 adjusts the text configuration region presented in the first style to the second style. The second style indicates that the text configuration region is in an editing state. As shown in the example interfaces 200B to 200C in FIGS. 2B to 2C, the terminal device 120 adjusts a border 221 corresponding to the title configuration region 211 to a border 234 of another style if it detects that a user gesture is hovering over the title configuration region 211.

In some embodiments, the identification information 241 input by the user in input box 231 indicates that an encoding of multiple text attributes (e.g., multiple languages) is provided via the text service platform. Therefore, the user 125 can invoke only one piece of the identification information 241 to obtain all attribute values corresponding to the field (for example, Chinese, English, and the like corresponding to the multiple languages).

In some embodiments, the terminal device 120 generates one or more contents to be distributed corresponding to the one or more attribute values respectively according to the target identification information and the target template, wherein each content to be distributed has a corresponding attribute value in the text configuration region. In some examples, if the identification information 241 indicates an encoding of multiple languages, the terminal device 120 may generate, according to the identification information 241 and the target template, contents to be distributed each having a text in Chinese, English, or Japanese, respectively. If the identification information 241 indicates an encoding of a plurality of language styles, the terminal device 120 generates, according to the identification information 241 and the target template, contents to be distributed each having a humorous style, a lively style, or a dignified style, respectively.

In some embodiments, after generating the content(s) to be distributed, the terminal device 120 may further present one or more preview controls respectively corresponding to one or more attribute values. If the terminal device 120 detects a trigger operation on the one or more preview controls, a preview content corresponding to the target template is presented. The preview content has an attribute value corresponding to the triggered preview control in the text configuration region. As shown in the exemplary interface 200D in FIG. 2D, the terminal device 120 may present a preview control 242 for language A, a preview control 243 for language B, and a preview control 244 for language C in an upper region 245 of a title W configuration region 246.

In some examples, if the user 125 clicks on the preview control 242 for language A, the terminal device 120 will present the title W in language A for the user 125 to preview. If the user 125 clicks on the preview control 243 in language B, the terminal device 120 will present the title W in language B for preview by the user 125. If the user 125 clicks on the preview control 244 in language C, the terminal device 120 will present the title W in language C for the user 125 to preview. In this way, the user can view the display effects of different attribute values simply, in real time and efficiently.

In some embodiments, after the user 125 inputs the identification information 241 into the input box 231, the terminal device 120 calls the text service platform to obtain the attribute value of the corresponding text attribute according to the identification information 241. The terminal device 120 then embeds the attribute value into the target template to generate the content to be distributed. In some examples, the text service platform may provide various services related to the text, such as various language translation services, text stylization services, text font setting services, etc.

After the terminal device 120 generates the contents to be distributed, the content distribution platform 110 can distribute the contents to be distributed to different users. For example, if the content distribution platform 110 identifies, by using a machine learning model, that the user A is elderly and the used language is Chinese, the content distribution platform 110 may send, to the user A, the content to be distributed corresponding to the Chinese text and the dignified style of language. As another example, if the content distribution platform 110 identifies, by using the machine learning model, that the user B is a young person and the used language is English, the content to be distributed corresponding to the English text and the lively style of language may be sent to the user B.

In conclusion, by using the identification information, various text attributes such as various languages may be input in the service providing platform and displayed. Further, the editable text configuration region can be emphasized in a way of masking and highlighting, and one or more presented preview controls can allow the user to view the effects of different languages quickly.

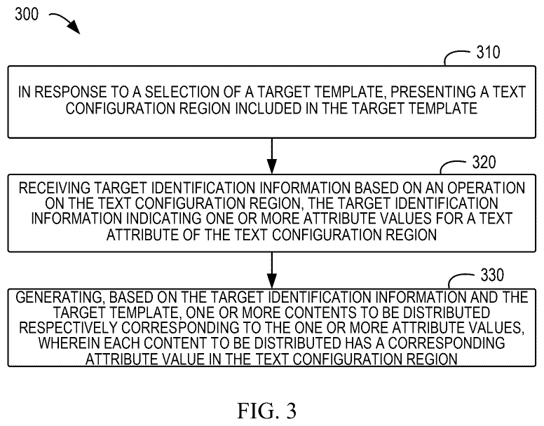

FIG. 3 illustrates a flowchart of a process 300 for content generation according to some embodiments of the disclosure. The process 300 may be implemented at the terminal device 120. The process 300 is described below with reference to FIG. 1.

At block 310, the terminal device 120 presents a text configuration region included in a target template in response to a selection of the target template.

At block 320, the terminal device 120 receives target identification information based on an operation on the text configuration region, the target identification information indicating one or more attribute values for the text attribute of the text configuration region.

At block 330, the terminal device 120 generates, based on the target identification information and the target template, one or more contents to be distributed corresponding to the one or more attribute values respectively, wherein each content to be distributed has a corresponding attribute value in the text configuration region.

In some embodiments, the process 300 further includes presenting one or more preview controls respectively corresponding to the one or more attribute values; and in response to a trigger operation on a preview control in one or more preview controls, presenting a preview content corresponding to a target template, wherein the preview content has an attribute value corresponding to the triggered preview control in a text configuration region.

In some embodiments, the text configuration region is highlighted in a first style.

In some embodiments, the process 300 further includes adjusting the text configuration region presented in a first style to a second style in response to a preset operation on the text configuration region, the second style indicating that the text configuration region is in an editing state.

In some embodiments, receiving target identification information comprises in response to a trigger operation on the text configuration region, presenting a target input box and prompt information, wherein the prompt information is used for prompting a user to input the identification information; and receiving the target identification information via the target input box.

In some embodiments, the process 300 further includes determining the text configuration region by: determining a text to be updated in the target template; and determining a region where the text to be updated is located as the text configuration region.

In some embodiments, the process 300 further comprises: determining preset information related to a target template; and determining a region where the preset information is placed as a pre-configuration region, the pre-configuration region being displayed in a style different from that of the text configuration region.

In some embodiments, the text attribute includes at least one of a language of text, a style of text, or a font of text.

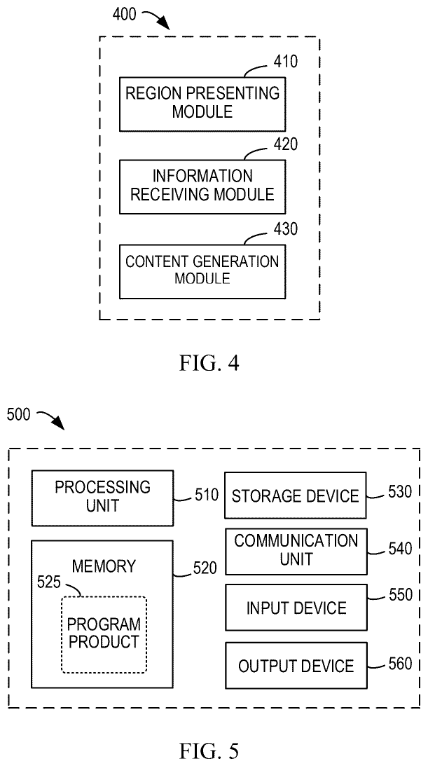

FIG. 4 shows a schematic structural block diagram of an apparatus 400 for content generation according to some embodiments of the present disclosure. The apparatus 400 may be implemented as or included in the terminal device 120. The various modules/components in the apparatus 400 may be implemented by hardware, software, firmware, or any combination thereof.

As shown, apparatus 400 includes a region presenting module 410 configured to present a text configuration region included in a target template in response to a selection of the target template. The apparatus 400 further comprises an information receiving module 420 configured to receive target identification information based on an operation on the text configuration region, the target identification information indicating one or more attribute values for a text attribute of the text configuration region. The apparatus 400 further comprises a content generation module 430, which is configured to generate one or more contents to be distributed respectively corresponding to the one or more attribute values based on the target identification information and the target template, wherein each content to be distributed has a corresponding attribute value in a text configuration region.

In some embodiments, the apparatus 400 further comprises a control presenting module configured to present one or more preview controls respectively corresponding to the one or more attribute values; and in response to a trigger operation on a preview control in the one or more preview controls, present a preview content corresponding to the target template, wherein the preview content has an attribute value corresponding to the triggered preview control in the text configuration region.

In some embodiments, the text configuration region is highlighted in a first style.

In some embodiments, the apparatus 400 further comprises a style adjustment module configured to adjust a text configuration region presented in the first style to a second style in response to a preset operation on the text configuration region, the second style indicating that the text configuration region is in an editing state.

In some embodiments, the information receiving module 420 is further configured to present a target input box and prompt information in response to a trigger operation on the text configuration region, the prompt information being configured to prompt a user to input the identification information; and receiving the target identification information via the target input box.

In some embodiments, the apparatus 400 further comprises a region determination module configured to determine the text configuration region by: determining a text to be updated in the target template; and determine a region where the text to be updated is located as the text configuration region.

In some embodiments, the apparatus 400 further comprises a preset information determination module configured to determine preset information related to the target template; and determine a region where the preset information is placed as a pre-configuration region, the pre-configuration region being presented in a style different from that of the text configuration region.

In some embodiments, the text attribute includes at least one of a language of text, a style of text, or a font of text.

FIG. 5 illustrates a block diagram of an electronic device 500 in which one or more embodiments of the present disclosure may be implemented. It should be appreciated that the electronic device 500 shown in FIG. 5 is merely exemplary and should not constitute any limitation on the functionality and scope of the embodiments described herein. The electronic device 500 shown in FIG. 5 may be used to implement the terminal device 120 of FIG. 1.

As shown in FIG. 5, the electronic device 500 is in the form of a general-purpose electronic device. The components of the electronic device 500 may include, but are not limited to, one or more processors or processing units 510, a memory 520, a storage 530, one or more communication units 540, one or more input devices 550, and one or more output devices 560. The processing unit 510 may be an actual or virtual processor and capable of performing various processes according to a program stored in the memory 520. In a multiprocessor system, a plurality of processing units execute computer executable instructions in parallel to improve the parallel processing capability of the electronic device 500.

The electronic device 500 typically includes a variety of computer storage media. Such media may be any available media that is accessible to the electronic device 500, including, but not limited to, volatile and non-volatile media, removable and non-removable media. The memory 520 may be a volatile memory (e.g., a register, cache, random access memory (RAM)), non-volatile memory (e.g., read-only memory (ROM), electrically erasable programmable read-only memory (EEPROM), flash memory), or some combination thereof. The storage 530 may be a removable or non-removable medium and may include a machine-readable medium such as a flash drive, a magnetic disk, or any other medium that may be used to store information and/or data and that can be accessed within the electronic device 500.

The electronic device 500 may further comprise an additional removable/non-removable, volatile/nonvolatile storage media. Although not shown in FIG. 5, a magnetic disk drive for reading from or writing to a removable, nonvolatile magnetic disk such as a “floppy disk” or an optical disk drive for reading from or writing to a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 implements communication with other electronic devices through a communication medium. In addition, functions of components of the electronic device 500 may be implemented by a single computing cluster or a plurality of computing machines capable of communicating through a communication connection. Accordingly, the electronic device 500 may operate in a networked environment using a logical connection to one or more other servers, network personal computers (PCs), or another network node.

The input device 550 may be one or more input devices such as a mouse, a keyboard, a trackball, etc. The output device 560 may be one or more output devices such as a display, speaker, printer, etc. The electronic device 500 may also communicate with one or more external devices (not shown), such as a storage device, display device, etc., through the communication unit 540 as needed. The one or more external devices communicate with one or more devices that enable users to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to exemplary implementations of the present disclosure, a computer-readable storage medium having computer-executable instructions stored thereon is provided. The computer-executable instructions are executed by a processor to implement the method described above. According to exemplary implementations of the present disclosure, a computer program product is also provided. The computer program product is tangibly stored on a non-transitory computer-readable medium and includes computer-executable instructions that are executed by a processor to implement the method described above.

Aspects of the present disclosure are described herein with reference to the flowchart and/or block diagrams of methods, apparatus, devices and computer program products implemented in accordance with the present disclosure. It would be appreciated that each block of the flowchart and/or block diagrams, and combinations of blocks in the flowchart and/or block diagrams, can be implemented by computer-readable program instructions.

These computer-readable program instructions may be provided to a processing unit of a general-purpose computer, special purpose computer, or another programmable data processing apparatus to produce a machine that generates an apparatus to implement the functions/acts specified in one or more blocks in the flow chart and/or the block diagram when these instructions are executed through the processing units of the computer or other programmable data processing devices. These computer-readable program instructions may also be stored in a computer-readable storage medium that can cause a computer, programmable data processing apparatus, and/or other devices to work in a specific way. Therefore, the computer-readable medium storing the instructions includes an article of manufacture including instructions which implement various aspects of the functions/acts specified in the one or more blocks in the flowchart and/or block diagram(s).

The computer readable program instructions may be loaded onto a computer, other programmable data processing apparatus, or other devices, such that a series of operational steps can be performed on a computer, other programmable data processing apparatus, or other devices, to produce a computer implemented process such that the instructions executed on the computer, other programmable data processing apparatus, or other devices implement the functions/acts specified in the one or more blocks in the flowchart and/or block diagram(s).

The flowchart and block diagrams in the drawings illustrate the possible architecture, functions, and operations of the systems, methods and computer program products implemented according to various implementations of the present disclosure. In this regard, each block in the flowchart or block diagrams may represent a module, a program segment, or instructions which contain one or more executable instructions for implementing the specified logic function(s). In some alternative implementations, the functions marked in the blocks may occur in a different order from those marked in the drawings. For example, two consecutive blocks shown may, in fact, be executed in parallel, and sometimes can also be executed in a reverse order, depending on the functions involved. It should also be noted that each block in the block diagrams and/or the flowchart, and combinations of blocks in the block diagrams and/or the flowchart, may be implemented by a dedicated hardware-based system that performs the specified functions or acts, or by the combination of a dedicated hardware and computer instructions.

Various implementations of the present disclosure have been described above. The above description is exemplary, not exhaustive, and the present application is not limited to the disclosed implementations. Without departing from the scope and spirit of the described implementations, many modifications and changes are obvious to those skilled in the art. The terminology used herein has been chosen to best explain the principles of the respective implementations, the practical applications or improvements to the technology in the marketplace, or to enable those skilled in the art to understand the implementations disclosed herein.

1. A method for content generation, comprising:
in response to a selection of a target template, presenting a text configuration region included in the target template;
receiving target identification information based on an operation on the text configuration region, the target identification information indicating one or more attribute values for a text attribute of the text configuration region; and
generating, based on the target identification information and the target template, one or more contents to be distributed respectively corresponding to the one or more attribute values, wherein each content to be distributed has a corresponding attribute value in the text configuration region.

2. The method of claim 1, further comprising:
presenting one or more preview controls respectively corresponding to the one or more attribute values; and
in response to a trigger operation on a preview control in the one or more preview controls, presenting a preview content corresponding to the target template, wherein the preview content has an attribute value corresponding to the triggered preview control in the text configuration region.

3. The method of claim 1, wherein the text configuration region is highlighted in a first style.

4. The method of claim 3, further comprising:
in response to a preset operation on the text configuration region, adjusting the text configuration region presented in the first style to a second style, the second style indicating that the text configuration region is in an editing state.

5. The method of claim 1, wherein receiving the target identification information comprises:
in response to a trigger operation on the text configuration region, presenting a target input box and prompt information, wherein the prompt information is configured to prompt a user to input identification information; and
receiving the target identification information via the target input box.

6. The method of claim 1, further comprising determining the text configuration region by:
determining a text to be updated in the target template; and
determining a region where the text to be updated is placed as the text configuration region.

7. The method of claim 6, further comprising:
determining preset information related to the target template; and
determining a region where the preset information is placed as a preconfigured region, wherein the preconfigured region is presented in a different style from the text configuration region.

8. The method of claim 1, wherein the text attribute comprises at least one of the following:
a language of text,
a style of text, or
a font of text.

9. An electronic device, comprising:
at least one processing unit; and
at least one memory coupled to the at least one processing unit and storing instructions for execution by the at least one processing unit that, the instructions, when executed by the at least one processing unit, causing the electronic device to perform acts comprising:
in response to a selection of a target template, presenting a text configuration region included in the target template;
receiving target identification information based on an operation on the text configuration region, the target identification information indicating one or more attribute values for a text attribute of the text configuration region; and
generating, based on the target identification information and the target template, one or more contents to be distributed respectively corresponding to the one or more attribute values, wherein each content to be distributed has a corresponding attribute value in the text configuration region.

10. The electronic device of claim 9, wherein the acts further comprise:
presenting one or more preview controls respectively corresponding to the one or more attribute values; and
in response to a trigger operation on a preview control in the one or more preview controls, presenting a preview content corresponding to the target template, wherein the preview content has an attribute value corresponding to the triggered preview control in the text configuration region.

11. The electronic device of claim 9, wherein the text configuration region is highlighted in a first style.

12. The electronic device of claim 11, wherein the acts further comprise:
in response to a preset operation on the text configuration region, adjusting the text configuration region presented in the first style to a second style, the second style indicating that the text configuration region is in an editing state.

13. The electronic device of claim 9, wherein receiving the target identification information comprises:
in response to a trigger operation on the text configuration region, presenting a target input box and prompt information, wherein the prompt information is configured to prompt a user to input identification information; and
receiving the target identification information via the target input box.

14. The electronic device of claim 9, wherein the acts further comprise determining the text configuration region by:
determining a text to be updated in the target template; and
determining a region where the text to be updated is placed as the text configuration region.

15. The electronic device of claim 14, wherein the acts further comprise:
determining preset information related to the target template; and
determining a region where the preset information is placed as a preconfigured region, wherein the preconfigured region is presented in a different style from the text configuration region.

16. The electronic device of claim 9, wherein the text attribute comprises at least one of the following:
a language of text,
a style of text, or
a font of text.

17. A non-transitory computer readable storage medium, having a computer program stored thereon, wherein the computer program is executable by a processor to implement a method comprising:
in response to a selection of a target template, presenting a text configuration region included in the target template;
receiving target identification information based on an operation on the text configuration region, the target identification information indicating one or more attribute values for a text attribute of the text configuration region; and
generating, based on the target identification information and the target template, one or more contents to be distributed respectively corresponding to the one or more attribute values, wherein each content to be distributed has a corresponding attribute value in the text configuration region.

18. The computer readable storage medium of claim 17, wherein the method further comprises:
presenting one or more preview controls respectively corresponding to the one or more attribute values; and
in response to a trigger operation on a preview control in the one or more preview controls, presenting a preview content corresponding to the target template, wherein the preview content has an attribute value corresponding to the triggered preview control in the text configuration region.

19. The computer readable storage medium of claim 17, wherein the text configuration region is highlighted in a first style.

20. The computer readable storage medium of claim 19, wherein the method further comprises:
in response to a preset operation on the text configuration region, adjusting the text configuration region presented in the first style to a second style, the second style indicating that the text configuration region is in an editing state.
